(19) United States
(12) Patent Application Publication
(10) Pub. No.: US 2025/0086986 A1
(43) Pub. Date: Mar. 13, 2025

(54) DRIVER MONITORING SYSTEM

(71) Applicant: TOYOTA JIDOSHA KABUSHIKI KAISHA, Toyota-shi (JP)

(72) Inventors: Jiro FUJINO, Tokyo (JP); Kenichiroh HARA, Yokohama-shi (JP); Kenta YAMADA, Tokyo (JP)

(73) Assignee: TOYOTA JIDOSHA KABUSHIKI KAISHA, Toyota-shi (JP)

(21) Appl. No.: 18/789,895

(22) Filed: Jul. 31, 2024

(30) Foreign Application Priority Data
Sep. 13, 2023 (JP) 2023-148219

(51) Int. Cl. G06V 20/59; G06T 7/90; G06V 40/16; G06V 40/18

(52) U.S. Cl. CPC G06V 20/59; G06T 7/90; G06V 40/162; G06V 40/18; G06T 2207/10024; G06T 2207/10048

(57) ABSTRACT

There is provided a driver monitoring system configured to perform face recognition of a driver from a face image of the driver of a vehicle, the system including: an infrared image capturing unit configured to capture an infrared image of a face of the driver using an infrared light emitting unit and an infrared light receiving unit; a visible light image capturing unit configured to capture a visible light image of the face of the driver using a visible light receiving unit; a color recognition unit configured to recognize a color of the driver's face based on the visible light image; and a face recognition unit configured to perform the face recognition of the driver based on the color of the driver's face and the infrared image.

### CROSS-REFERENCE TO RELATED APPLICATIONS

This application is based upon and claims the benefit of priority from Japanese Patent Application No. 2023-148219, filed On Sep. 13, 2023, the entire contents of which are incorporated herein by reference.

### TECHNICAL FIELD

The present disclosure relates to a driver monitoring system.

### BACKGROUND

Conventionally, Japanese Unexamined Patent Publication No. 2006-095008 has been known as a technical document regarding a driver monitoring system. In this publication, a line-of-sight vector detection system which includes an infrared light source that irradiates at least one of eyes and a face with infrared light; a camera that captures an image of at least one of the eyes and the face; and a calculator that processes captured image data of the camera to calculate a line-of-sight vector, and which detects a true bright spot and the centers of a pupil from the captured image data to calculate the line-of-sight vector has been shown.

### SUMMARY

It is known that the reflectance of infrared light changes depending on the color of a face of a driver of a vehicle. In addition, the reflectance of infrared light also changes depending on makeup such as eyeshadow. As a result, there is a risk that the accuracy of face recognition of the driver using an infrared image may decreases, which is a problem.

According to one aspect of the present disclosure, there is provided a driver monitoring system configured to perform face recognition of a driver from a face image of the driver of a vehicle, the system including: an infrared image capturing unit configured to capture an infrared image of a face of the driver using an infrared light emitting unit and an infrared light receiving unit; a visible light image capturing unit configured to capture a visible light image of the face of the driver using a visible light receiving unit; a color recognition unit configured to recognize a color of the driver's face based on the visible light image; and a face recognition unit configured to perform the face recognition of the driver based on the color of the driver's face and the infrared image.

According to the driver monitoring system according to one aspect of the present disclosure, since the face recognition of the driver is performed from the color of the driver's face recognized based on the visible light image and the infrared image, the accuracy of the face recognition of the driver can be improved by combining the infrared image that is less likely to be affected by sunlight, lighting inside the vehicle, or the like and the visible light image that provides specific color information.

In the driver monitoring system according to one aspect of the present disclosure, the color of the driver's face may include a color of eyes of the driver, and the face recognition unit may be configured to change a face recognition logic for the driver in the infrared image according to the color of the eyes of the driver.

According to the driver monitoring system, since the visible light image of the driver is captured to recognize the color of the eyes of the driver, and the face recognition logic for the driver using the infrared image is changed based on the color of the eyes of the driver, the accuracy of the face recognition can be improved compared to when the face recognition of the driver is performed from the infrared image without taking into consideration the color of the eyes of the driver.

In the driver monitoring system according to one aspect of the present disclosure, when the color of the eyes of the driver is black, the face recognition of the driver may be performed from the infrared image using a face recognition logic for black eyes, and when the color of the eyes of the driver is blue, the face recognition of the driver may be performed from the infrared image using a face recognition logic for blue eyes.

In the driver monitoring system according to one aspect of the present disclosure, the visible light image capturing unit may be configured to capture the visible light image of the driver when the driver is seated in a driver's seat of the vehicle or when an engine of the vehicle is started.

In the driver monitoring system according to one aspect of the present disclosure, the face recognition unit may be configured to perform the face recognition of the driver from the face image of the driver using a face recognition model that is a machine learning model, and one face recognition model may be selected from a plurality of the face recognition models provided in advance, according to the color of the eyes of the driver, and the face recognition of the driver in the infrared image may be performed using the selected face recognition model.

The driver monitoring system according to one aspect of the present disclosure may further include an opening and closing determination unit configured to perform a determination of opening and closing of eyes of the driver based on a color of skin around the eyes of the driver included in the color of the driver's face and the infrared image, and the opening and closing determination unit may be configured to change an opening and closing determination logic for the eyes of the driver in the infrared image according to the color of the skin around the eyes of the driver.

In the driver monitoring system according to one aspect of the present disclosure, the color of the driver's face may include a color of the eyes of the driver, and the opening and closing determination unit may be configured to change the opening and closing determination logic for the eyes of the driver in the infrared image according to the color of the eyes of the driver and the color of the skin around the eyes of the driver.

In the driver monitoring system according to one aspect of the present disclosure, the opening and closing determination unit may be configured to perform the determination of opening and closing of the eyes of the driver from the face image of the driver using an opening and closing determination model that is a machine learning model, and one opening and closing determination model may be selected from a plurality of the opening and closing determination models provided in advance, according to the color of the skin around the eyes of the driver, and the determination of opening and closing of the eyes of the driver in the infrared image may be performed using the selected opening and closing determination model.

The driver monitoring system according to one aspect of the present disclosure may further include an opening degree calculation unit configured to calculate an opening degree of a mouth of the driver based on the color of the driver's face including a color of lips of the driver and the infrared image, and the opening degree calculation unit may be configured to extract feature points of the mouth of the driver from the infrared image, correct the feature points of the mouth based on a boundary between a color portion of the lips of the driver and a color portion of skin of the face from the visible light image, and calculate the opening degree of the mouth of the driver based on the corrected feature points of the mouth.

In the driver monitoring system according to one aspect of the present disclosure, the opening degree calculation unit may be configured to determine whether the color of the lips of the driver is within a non-makeup range estimated from a color of the skin of the face, perform the calculation of the opening degree when the color of the lips of the driver is within the non-makeup range, and not perform the calculation of the opening degree when the color of the lips of the driver is not within the non-makeup range.

According to the driver monitoring system according to each aspect of the present disclosure, the accuracy of the face recognition of the driver of the vehicle can be improved.

### BRIEF DESCRIPTION OF THE DRAWINGS

FIG. 1 is a block diagram showing a driver monitoring system according to a first embodiment.

FIG. 2 is a view for describing one example of the disposition of a driver camera monitor.

FIG. 3 is a flowchart for describing one example of a face recognition process.

FIG. 4 is a block diagram showing a driver monitoring system according to a second embodiment.

FIG. 5 is a flowchart showing one example of an opening and closing determination process.

FIG. 6 is a block diagram showing a driver monitoring system according to a third embodiment.

FIG. 7A is a view showing an example in which false detection of feature points occurs due to light hitting a face of a driver unevenly.

FIG. 7B is a view showing another example in which false detection of feature points due to light hitting the face of the driver unevenly.

FIG. 8 is a flowchart showing one example of an opening degree calculation process.

### DETAILED DESCRIPTION

Hereinafter, embodiments of the present disclosure will be described with reference to the drawings.

### First Embodiment

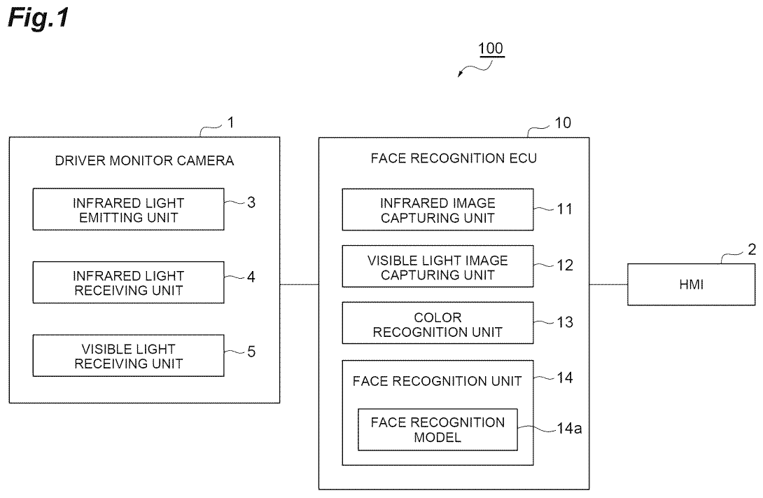

FIG. 1 is a block diagram showing a driver monitoring system 100 according to a first embodiment. The driver monitoring system 100 shown in FIG. 1 is installed in a vehicle such as a passenger car or a truck to monitor a state of a driver of the vehicle. The driver monitoring system 100 performs face recognition of the driver based on a face image of the driver captured by a driver monitor camera 1 provided in the vehicle. The driver monitoring system 100 may constitute a part of at least one of an autonomous driving system and an advanced driving assistance system.

The driver monitoring system 100 takes into consideration a color of eyes of the driver in the face recognition of the driver. It has been found that since the reflectance of light changes depending on the color of the eyes of the driver, the reception result of infrared light to be described later changes. For this reason, the driver monitoring system 100 improves the recognition accuracy of face recognition such as a line-of-sight angle of the driver by changing a face recognition logic in consideration of the color of the eyes of the driver. Accordingly, the accuracy of the determination of driver distraction or the like can be improved.

The driver monitoring system 100 includes a face recognition ECU 10 that comprehensively manages the system. The face recognition ECU 10 is an electronic control unit including a central processing unit (CPU) and a storage unit. The storage unit is made up of, for example, a read only memory (ROM), a random access memory (RAM), an electrically erasable programmable read-only memory (EEPROM), and the like. In the face recognition ECU 10, the CPU executes various functions by executing a program stored in the storage unit. The face recognition ECU 10 may be made up of a plurality of electronic units.

The face recognition ECU 10 is connected to the driver monitor camera 1 and a human machine interface (HMI) 2.

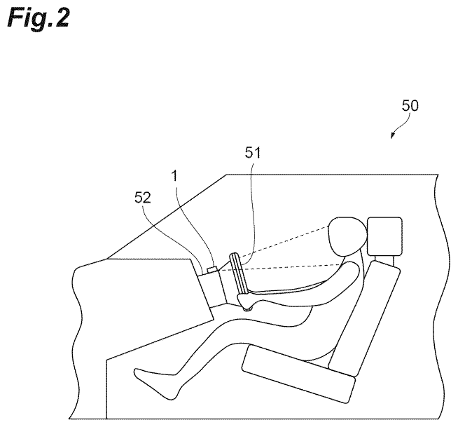

The driver monitor camera 1 is an imaging device that captures an image of a face of the driver of the vehicle. The driver monitor camera 1 is provided, for example, at a position in front of the driver in the vehicle. Here, FIG. 2 is a view for describing one example of the disposition of the driver monitor camera 1. FIG. 2 shows a vehicle 50, a steering wheel 51, a steering column 52, and the driver monitor camera 1. As shown in FIG. 2, the driver monitor camera 1 is provided, for example, on the steering column 52, and captures an image of a head including the face of the driver at a predetermined frame rate.

In FIG. 2, the projection range of the driver monitor camera 1 is shown by a dotted line. The driver monitor camera 1 may be provided on the steering wheel 51, a rearview mirror, an instrument panel, an instrument cluster hood, or the like of the vehicle 50.

Next, a configuration of the driver monitor camera 1 will be described. As shown in FIG. 1, the driver monitor camera 1 includes an infrared light emitting unit 3, an infrared light receiving unit 4, and a visible light receiving unit 5. The infrared light emitting unit 3 is a light emitting element that generates infrared light. As the infrared light emitting unit 3, for example, an infrared light emitting diode (LED), an infrared laser diode, or the like can be employed. The infrared light is used to illuminate the face of the driver.

The infrared light receiving unit 4 is a light receiving element that receives infrared light after being generated from the infrared light emitting unit 3 and then being reflected by the driver. As the infrared light receiving unit 4, an infrared sensor, an infrared camera, or the like can be employed. The driver monitor camera 1 can clearly capture an image of a state of the driver and acquire an infrared image even at night or in a dark environment using the infrared light emitting unit 3 and the infrared light receiving unit 4.

The visible light receiving unit 5 is a light receiving element that receives visible light. As the visible light receiving unit 5, for example, a charge coupled device (CCD), a CMOS image sensor (CIS), or the like can be employed. The visible light receiving unit 5 acquires a visible light image of the face of the driver by receiving at least one of sunlight reflected on the face of the driver and light from lighting outside or inside the vehicle.

The HMI 2 is an interface for performing the input and output of information between the face recognition ECU 10 and the driver. The HMI 2 includes, for example, a display, a speaker, and the like provided in a vehicle interior. The HMI 2 performs image output from the display and audio output from the speaker in response to a control signal from the face recognition ECU 10. The display may be at least one of a multi-information display (MID) and a headup display (HUD). The HMI 2 may include various indicators.

Next, a functional configuration of the face recognition ECU 10 will be described. As shown in FIG. 1, the face recognition ECU 10 includes an infrared image capturing unit 11, a visible light image capturing unit 12, a color recognition unit 13, and a face recognition unit 14.

The infrared image capturing unit 11 captures an infrared image of the face of the driver using the infrared light emitting unit 3 and the infrared light receiving unit 4 of the driver monitor camera 1. The infrared image is an image captured using infrared light. The infrared image is an image that can be clearly captured even at night or in a dark location without being affected by the state (at least one of brightness and darkness) of light.

The visible light image capturing unit 12 captures a visible light image of the face of the driver using the visible light receiving unit 5 of the driver monitor camera 1. The visible light image is an image captured using visible light. The visible light images include color information (RGB information and the like). The wavelength range of the visible light image is not particularly limited; however, a mode in which only a part of the wavelength range is used may be employed.

The visible light image capturing unit 12 may capture a visible light image for each frame if a situation where an image can be captured is met, or may capture a visible light image of the driver when the driver is seated in a driver's seat of the vehicle 50 or when an engine of the vehicle is started. The determination of the driver being seated may be performed based on the detection result of the wearing of a seat belt by a seat belt sensor of the driver's seat, or may be performed based on a detection result of a seat sensor of the driver's seat. The seating sensor is made up of, for example, a pressure sensor. Even at night or in a situation where sunlight does not illuminate the driver inside a building, since it is considered that an interior light of the vehicle 50 is turned on when the driver is seated in the driver's seat or the engine of the vehicle is started, the visible light image capturing unit 12 can capture a visible light image of the face of the driver using the visible light receiving unit 5.

The color recognition unit 13 recognizes a color of the driver's face based on the visible light image. The color of the driver's face may include a color of each part of the driver such as eyes, nose, and mouth, and may include a color around each part. The color recognition unit 13 recognizes, for example, a pixel region constituting each part of the driver such as eyes, nose, and mouth from the visible light image. The color recognition unit 13 performs color recognition of each part from color information (chromaticity parameter and the like) of the pixel region of each part.

Regarding the color of the eyes of the driver, the color recognition unit 13 may use a recognition result of a color of eyes of a past driver when a driver personal authentication function is installed in the vehicle 50. It can be considered that the color of the eyes basically does not change.

The face recognition unit 14 recognizes the face of the driver based on the color of the driver's face recognized by the color recognition unit 13 and the infrared image captured by the infrared image capturing unit 11. The face recognition unit 14 performs face recognition of the driver using a face recognition logic provided in advance. The face recognition unit 14 recognizes, for example, a face region in the infrared image from a pattern of the face. The pattern of the face is, for example, the disposition of the eyes, nose, and mouth. For the recognition of the face region, for example, Haar-like features, histogram of oriented gradients (HOG) features, or the like can be used.

The face recognition unit 14 extracts feature quantities characterizing the face from the face region. The feature quantities of the face include, for example, the shape of the face, the positions of the eyes, nose, or mouth, and the like. A method such as a principal component analysis (PCA) or a local binary pattern (LBP) can be used to extract the feature quantities. The face recognition unit 14 recognizes a face orientation, a face position, a line-of-sight angle, and the like of the driver from the feature quantities. The face recognition logic is not limited to the above-described contents, and well-known logics can be employed.

The face recognition unit 14 may be able to change the face recognition logic for the driver according to the color of the eyes of the driver recognized by the color recognition unit 13. Namely, the face recognition unit 14 may be able to use a plurality of types of the face recognition logics. Specifically, the face recognition unit 14 may be able to use at least two of a normal face recognition logic, a face recognition logic for black eyes, a face recognition logic for blue eyes, a face recognition logic for brown eyes, a face recognition logic for green eyes, a face recognition logic for gray eyes, and a face recognition logic for amber eyes.

The face recognition logic for black eyes is a face recognition logic set to increase the accuracy of face recognition on the assumption that the driver has black eyes. In the face recognition logic for black eyes, for example, detection parameters (a threshold value in edge processing and the like) are adjusted such that the accuracy of detection of a line of sight of the black eyes is higher compared to that in the normal face recognition logic. The same applies to the face recognition logic for blue eyes, the face recognition logic for brown eyes, the face recognition logic for green eyes, the face recognition logic for gray eyes, and the face recognition logic for amber eyes. The normal face recognition logic is a standard face recognition logic that does not perform parameter adjustment according to the color of the eyes. The normal face recognition logic can be, for example, a well-known face recognition logic that has been conventionally used.

When the color of the eyes of the driver recognized by the color recognition unit 13 is black, the face recognition unit 14 performs face recognition of the driver using the face recognition logic for black eyes. When the color of the eyes of the driver recognized by the color recognition unit 13 is blue, the face recognition unit 14 performs face recognition of the driver using the face recognition logic for blue eyes. The same applies to other colors of eyes.

The face recognition unit 14 may use a face recognition model 14a as the face recognition logic. The face recognition model 14a is, for example, a neural network such as a convolutional neural network (CNN). The neural network can include a plurality of layers including a plurality of convolutional layers and pooling layers. As the neural network, a deep learning network using deep learning is used. A recurrent neural network (RNN) may be used for the face recognition model 14a.

The face recognition model 14a outputs a result of the face recognition of the driver, for example, by taking the infrared image captured by the infrared image capturing unit 11 as an input. The face recognition model 14a may further take at least one of the visible light image and the recognition result of the color of the driver's face by the color recognition unit 13 as an input.

The face recognition unit 14 may select one face recognition model from a plurality of types of the face recognition models 14a provided in advance, according to the color of the eyes of the driver recognized by the color recognition unit 13, and may perform face recognition of the driver using the selected face recognition model. Namely, the face recognition unit 14 may have the plurality of types of face recognition models 14a. The face recognition unit 14 has, for example, at least two of a normal face recognition model, a face recognition model for black eyes, a face recognition model for blue eyes, a face recognition model for brown eyes, a face recognition model for green eyes, a face recognition model for gray eyes, and a face recognition model for amber eyes provided in advance, as the face recognition models 14a.

The face recognition model for black eyes is a machine learning model that is trained on a dataset including mainly a face image of a driver with black eyes. The face recognition model for black eyes improves the accuracy of face recognition of the driver with black eyes compared to the normal face recognition model. The same applies to the face recognition model for blue eyes, the face recognition model for brown eyes, the face recognition model for green eyes, the face recognition model for gray eyes, and the face recognition model for amber eyes.

The normal face recognition model is a machine learning model that is trained on a dataset without intentional bias induced by the color of the eyes with the intention of being versatile. The absence of intentional bias in the dataset does not mean that there is no bias in the dataset. Various different models may be employed depending on at least one of the country and the region. The various models may be downloadable from a server capable of communicating with the vehicle 50.

When the color of the eyes of the driver recognized by the color recognition unit 13 is black, the face recognition unit 14 performs face recognition using the face recognition model for black eyes. When the color of the eyes of the driver recognized by the color recognition unit 13 is blue, the face recognition unit 14 performs face recognition using the face recognition model for blue eyes. The same applies to other colors of eyes.

The face recognition unit 14 performs face recognition such as the face position, the face orientation, and the line of sight of the driver using the face recognition model 14a according to the color of the eyes of the driver. The face recognition unit 14 may perform the determination of driver distraction based on the result of the face recognition of the driver. When it is determined that the driver is distracted, the face recognition unit 14 may cause the HMI 2 to alert the driver through at least one of image display and sound output.

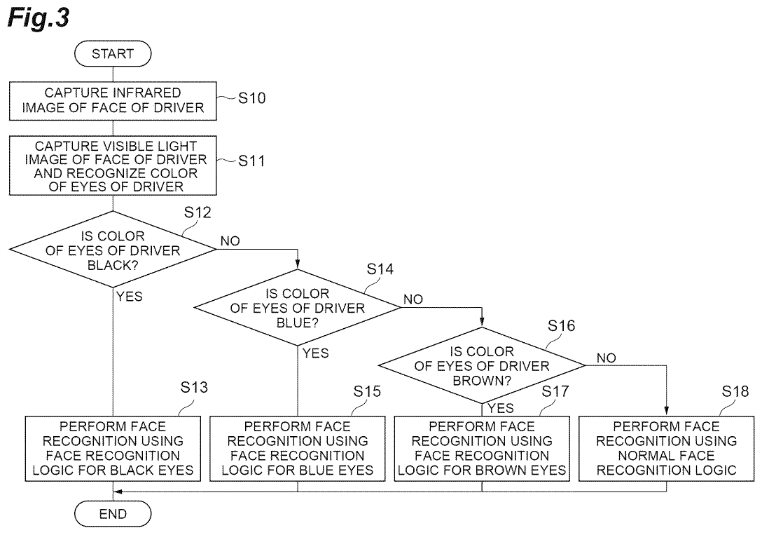

Next, a process of the driver monitoring system 100 will be described with reference to FIG. 3. FIG. 3 is a flowchart for describing one example of a face recognition process. The face recognition process is executed, for example, when a driver monitoring function of the vehicle 50 is turned on.

As shown in FIG. 3, in S10, the face recognition ECU 10 of the driver monitoring system 100 causes the infrared image capturing unit 11 to capture an infrared image of the face of the driver. Thereafter, the face recognition ECU 10 proceeds to S11.

In S11, the face recognition ECU 10 causes the visible light image capturing unit 12 to capture a visible light image of the face of the driver. In addition, the face recognition ECU 10 causes the color recognition unit 13 to recognize the color of the driver's face (including the color of the eyes). Thereafter, the face recognition ECU 10 proceeds to S12. S10 and S11 may be performed in reverse order, or may be performed at the same time.

In S12, the face recognition ECU 10 determines whether the color of the eyes of the driver is black. When it is determined that the color of the eyes of the driver is black (S12: YES), the face recognition ECU 10 proceeds to S13. When it is not determined that the color of the eyes of the driver is black (S12: NO), the face recognition ECU 10 proceeds to S14.

In S13, the face recognition ECU 10 causes the face recognition unit 14 to execute face recognition of the driver using the face recognition logic for black eyes. The face recognition unit 14 may use the face recognition model for black eyes as the face recognition logic for black eyes. The face recognition unit 14 outputs a result of the face recognition of the driver from the face recognition model for black eyes by taking the color of the driver's face recognized by the color recognition unit 13 and the infrared image captured by the infrared image capturing unit 11 as input. Thereafter, the face recognition process is ended.

In S14, the face recognition ECU 10 determines whether the color of the eyes of the driver is blue. When it is determined that the color of the eyes of the driver is blue (S14: YES), the face recognition ECU 10 proceeds to S15. When it is not determined that the color of the eyes of the driver is blue (S14: NO), the face recognition ECU 10 proceeds to S16.

In S15, the face recognition ECU 10 causes the face recognition unit 14 to execute face recognition of the driver using the face recognition logic for blue eyes. The face recognition unit 14 may use the face recognition model for blue eyes as the face recognition logic for blue eyes. The face recognition unit 14 outputs a result of the face recognition of the driver from the face recognition model for blue eyes by taking the color of the driver's face recognized by the color recognition unit 13 and the infrared image captured by the infrared image capturing unit 11 as inputs. Thereafter, the face recognition process is ended.

In S16, the face recognition ECU 10 determines whether the color of the eyes of the driver is brown. When it is determined that the color of the eyes of the driver is brown (S16: YES), the face recognition ECU 10 proceeds to S17. When it is not determined that the color of the eyes of the driver is brown (S16: NO), the face recognition ECU 10 proceeds to S18.

In S17, the face recognition ECU 10 causes the face recognition unit 14 to execute face recognition of the driver using the face recognition logic for brown eyes. The face recognition unit 14 may use the face recognition model for brown eyes as the face recognition logic for brown eyes. The face recognition unit 14 outputs a result of the face recognition of the driver from the face recognition model for brown eyes by taking the color of the driver's face recognized by the color recognition unit 13 and the infrared image captured by the infrared image capturing unit 11 as inputs. Thereafter, the face recognition process is ended.

In S18, the face recognition ECU 10 causes the face recognition unit 14 to execute face recognition of the driver using the normal face recognition logic. The face recognition unit 14 may use the normal face recognition model as the normal face recognition logic. The face recognition unit 14 outputs a result of the face recognition of the driver from the normal face recognition model by taking the color of the driver's face recognized by the color recognition unit 13 and the infrared image captured by the infrared image capturing unit 11 as inputs. Thereafter, the face recognition process is ended.

According to the driver monitoring system 100 according to the first embodiment described above, since a visible light image of the driver is captured to recognize the color of the eyes of the driver, and the face recognition logic (face recognition model) for the driver using an infrared image is changed based on the color of the eyes of the driver, the accuracy of face recognition can be improved compared to when face recognition of the driver is performed from the infrared image without taking into consideration the color of the eyes of the driver. In addition, in the driver monitoring system 100, face recognition of the driver is performed using a hybrid form of a visible light image passively acquired by the visible light receiving unit 5 of the driver monitor camera 1 and an infrared image. Accordingly, unlike a configuration in which the face of the driver is irradiated with visible light to acquire a visible light image with high accuracy, the driver monitoring system 100 can avoid causing the driver to feel glare due to light entering the eyes of the driver.

In addition, according to the driver monitoring system 100, when the color of the eyes of the driver is black, face recognition of the driver is performed from an infrared image using the face recognition logic for black eyes, and when the color of the eyes of the driver is blue, face recognition of the driver is performed from an infrared image using the face recognition logic for blue eyes, so that the accuracy of face recognition can be improved compared to when the same face recognition logic is used regardless of the color of the eyes.

Further, according to the driver monitoring system 100, since a visible light image of the driver is captured to recognize the color of the eyes of the driver, and the face recognition model for the driver using an infrared image is changed based on the color of the eyes of the driver, the accuracy of face recognition can be improved compared to when face recognition of the driver is performed from the infrared image without taking into consideration the color of the eyes of the driver.

In addition, according to the driver monitoring system 100, even at night, the color of the eyes of the driver can be appropriately recognized by capturing a visible light image of the driver when the driver is seated or when the engine is started.

### Second Embodiment

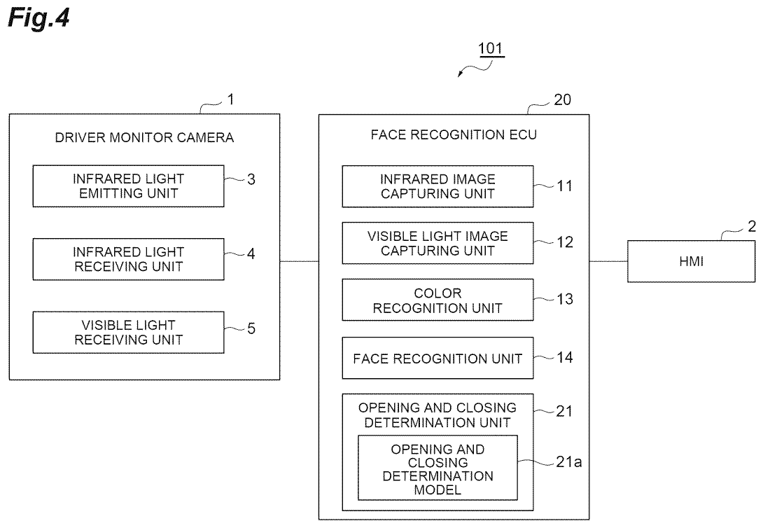

Next, a driver monitoring system 101 according to a second embodiment will be described with reference to the drawings. Configurations that are the same as or equivalent to those of the first embodiment are denoted by the same reference signs, and duplicate descriptions will be omitted. FIG. 4 is a block diagram showing the driver monitoring system 101 according to the second embodiment.

The driver monitoring system 101 according to the second embodiment shown in FIG. 4 performs the determination of opening and closing of the eyes of the driver as a face recognition of the driver. As shown in FIG. 4, a face recognition ECU 20 of the driver monitoring system 101 differs from that of the first embodiment in that the face recognition ECU 20 includes an opening and closing determination unit 21.

The driver monitoring system 101 takes into consideration the color of the skin around the eyes of the driver in determining whether the eyes of the driver are opened or closed. It has been found that since the reflectance of light on at least one of the skin and the eyes changes depending on the color of the skin and makeup around the eyes of the driver, and the reflection brightness of the vertices of curved surfaces thereof changes, a decrease in the accuracy of the opening and closing determination occurs. For this reason, the driver monitoring system 101 suppresses a decrease in the accuracy of the opening and closing determination by performing the determination of opening and closing of the eyes of the driver in consideration of the color of the skin around the eyes of the driver.

The opening and closing determination unit 21 performs the determination of opening and closing of the eyes of the driver based on the color of the skin around the eyes of the driver (also including the color of makeup on the skin) included in the color of the driver's face recognized by the color recognition unit 13 and an infrared image captured by the infrared image capturing unit 11. The color of the skin around the eyes of the driver can be defined, for example, as a color of skin within the range of a certain distance from a center point on a visible light image of the eyes of the driver in the skin of the face of the driver on the image. The color of the skin around the eyes of the driver may not necessarily be a color of skin within the certain distance from the eyes, and may be a color of skin within the range of a shape provided in advance and including the eyes.

The opening and closing determination unit 21 performs the determination of opening and closing of the eyes of the driver using an opening and closing determination logic for eyes provided in advance. The opening and closing determination unit 21 detects eye regions including the eyes of the driver recognized by the face recognition unit 14, and detects the positions of an upper eyelid and a lower eyelid from each eye region. The positions of the upper eyelid and the lower eyelid are determined, for example, by detecting edges (boundaries) of the eyelids. Thereafter, the opening and closing determination unit 21 measures a distance between the positions of the upper eyelid and the lower eyelid, and determines that the eye is closed, when the distance between the positions of the upper eyelid and the lower eyelid is less than a certain threshold value. When the state where the distance between the positions of the upper eyelid and the lower eyelid is less than the certain threshold value continues for a certain period of time or more, the opening and closing determination unit 21 may warn that there is a possibility that the driver is asleep. The opening and closing determination logic is not limited to the above-described contents, and well-known logics can be employed.

The opening and closing determination unit 21 may be able to change the opening and closing determination logic for the eyes of the driver in an infrared image according to the color of the skin around the eyes of the driver. Namely, the opening and closing determination unit 21 may be able to use a plurality of types of the opening and closing determination logic. Specifically, the opening and closing determination unit 21 may be able to use at least two of a normal opening and closing determination logic, an opening and closing determination logic for eyelids, and an opening and closing determination logic for makeup.

The opening and closing determination logic for eyelids is an opening and closing determination logic set to increase the accuracy of the determination of opening and closing of the eyes on the assumption that the driver does not wear dark makeup around the eyes. In the opening and closing determination logic for eyelids, for example, parameters (a threshold value in edge processing and the like) are adjusted such that the accuracy of detection of the positions of the skin-colored eyelids is higher than that in the normal opening and closing determination logic.

The opening and closing determination logic for makeup is an opening and closing determination logic set to suppress a decrease in the accuracy of the determination of opening and closing of the eyes on the assumption that the driver wears makeup around the eyes. In the opening and closing determination logic for makeup, for example, parameters are adjusted such that a line formed by makeup such as eyeshadow is less likely to be falsely detected as the positions of the eyelids compared to the normal opening and closing determination logic. The normal opening and closing determination logic is a standard opening and closing determination logic that does not perform parameter adjustment in which the presence or absence of makeup is taken into consideration. The normal opening and closing determination logic can be, for example, a well-known opening and closing determination logic that has been conventionally used.

When it is determined that regions around the eyes of the driver are in a non-makeup state, for example, based on the color of the skin around the eyes of the driver, the opening and closing determination unit 21 performs the determination of opening and closing of the eyes of the driver using the opening and closing determination logic for eyelids. The non-makeup state is a state where dark makeup such as eyeshadow causing false detection of the positions of the eyelids is not performed. When it is determined that the regions around the eyes of the driver are in a makeup state, for example, based on the color of the skin around the eyes of the driver, the opening and closing determination unit 21 may perform the determination of opening and closing of the eyes of the driver using the opening and closing determination logic for makeup.

The opening and closing determination unit 21 may further select an opening and closing determination logic based on the color of the eyes of the driver. For example, the opening and closing determination logic for eyelids may further include at least two of a black eye logic, a blue eye logic, a brown eye logic, a green eye logic, a gray eye logic, and an amber eye logic.

The black eye logic is an opening and closing determination logic set to increase the accuracy of face recognition on the assumption that the driver has black eyes, among the opening and closing determination logics for eyelids. In the black eye logic, detection parameters (a threshold value in edge processing and the like) are adjusted such that the accuracy of detection of the positions of the eyelids of the black eyes is increased. The same applies to the blue eye logic, the brown eye logic, the green eye logic, the gray eye logic, and the amber eye logic.

Similarly, the opening and closing determination logic for makeup may further include at least two of a black eye logic, a blue eye logic, a brown eye logic, a green eye logic, a gray eye logic, and an amber eye logic. In such a manner, by selecting an opening and closing determination logic also in consideration of the color of the eyes of the driver, the accuracy of the determination of opening and closing of the eyes of the driver can be increased.

The opening and closing determination unit 21 may use an opening and closing determination model 21a as the opening and closing determination logic. The opening and closing determination model 21a can be a neural network similar to the face recognition model 14a described above. Configurations of the neural networks of the opening and closing determination model 21a and the face recognition model 14a may be the same or different.

The opening and closing determination model 21a outputs a result of the determination of opening and closing of the eyes of the driver, for example, by taking the infrared image captured by the infrared image capturing unit 11 as an input. The opening and closing determination model 21a may further take as input at least one of the visible light image captured by the visible light image capturing unit 12 and the recognition result of the color of the driver's face by the color recognition unit 13. The opening and closing determination model 21a may output at least one of the distance between the upper eyelid and the lower eyelid of the driver and the positions of the eyelids instead of the result of the determination of opening and closing of the eyes of the driver.

The opening and closing determination unit 21 may select one opening and closing determination model among a plurality of types of the opening and closing determination models 21a provided in advance, based on the color of the skin around the eyes of the driver, and may perform the determination of opening and closing of the eyes of the driver using the selected opening and closing determination model.

Namely, the opening and closing determination unit 21 may have the plurality of types of opening and closing determination models 21a (opening and closing determination logics). The opening and closing determination unit 21 has, for example, at least two of a normal opening and closing determination model, an opening and closing determination model for eyelids, and an opening and closing determination model for makeup that are provided in advance, as the opening and closing determination models 21a.

The opening and closing determination model for eyelids is a machine learning model that is trained on a dataset including mainly a face image of the driver who does not wear makeup around the eyes. The opening and closing determination model for eyelids improves the accuracy of the determination of opening and closing of the eyes of the driver in a non-makeup state compared to the normal opening and closing determination model. The opening and closing determination model for makeup is a machine learning model that is trained on a dataset including mainly a face image of the driver who wears makeup such as eyeshadow around the eyes. The opening and closing determination model for makeup improves the accuracy of the determination of opening and closing of the eyes of the driver in a makeup state compared to the normal opening and closing determination model. The normal opening and closing determination model is a machine learning model that is trained on a dataset prepared regardless of the presence or absence of makeup with the intention of being versatile.

When it is determined that regions around the eyes of the driver are in a non-makeup state, for example, based on the color of the skin around the eyes of the driver, the opening and closing determination unit 21 performs the determination of opening and closing of the eyes of the driver using the opening and closing determination model for eyelids. In addition, when it is determined that the regions around the eyes of the driver are in a makeup state, for example, based on the color of the skin around the eyes of the driver, the opening and closing determination unit 21 may perform the determination of opening and closing of the eyes of the driver using the opening and closing determination model for makeup.

The opening and closing determination unit 21 may further select one of a plurality of types of the opening and closing determination models for eyelids based on the color of the eyes of the driver. For example, the opening and closing determination model for eyelids may further include at least two of a black eye model, a blue eye model, a brown eye model, a green eye model, a gray eye model, and an amber eye model.

The black eye model is an opening and closing determination model set to increase the accuracy of face recognition on the assumption that the driver has black eyes, among the opening and closing determination models for eyelids. In the black eye model, training is performed to increase the accuracy of detection of the positions of the eyelids of the black eyes. The same applies to the blue eye model, the brown eye model, the green eye model, the gray eye model, and the amber eye model.

Similarly, the opening and closing determination model for makeup may further include at least two of a black eye model, a blue eye model, a brown eye model, a green eye model, a gray eye model, and an amber eye model. In such a manner, by selecting an opening and closing determination model also in consideration of the color of the eyes of the driver, the accuracy of the determination of opening and closing of the eyes of the driver can be increased.

For example, when a state where the eyes of the driver are closed continues for a certain period of time or more during the traveling of the vehicle 50, based on the result of the determination of opening and closing of the eyes of the driver, the opening and closing determination unit 21 causes the HMI 2 to alert the driver through sound output. An alert is not mandatory.

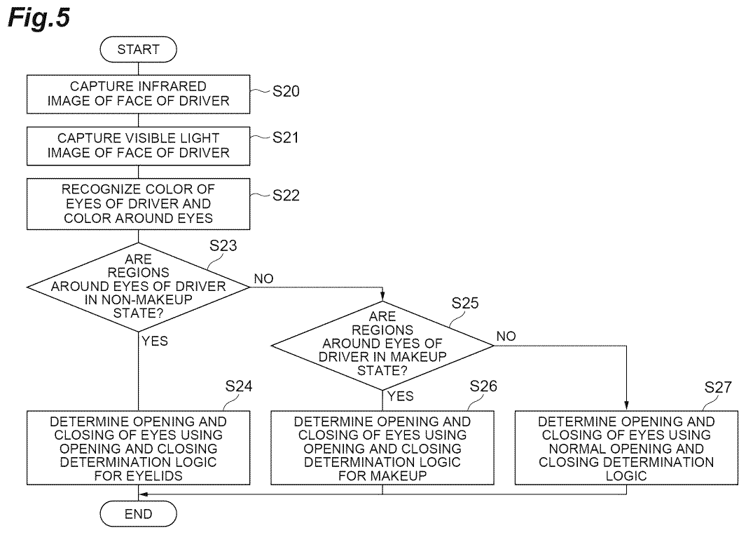

Next, a process of the driver monitoring system 101 will be described with reference to FIG. 5. FIG. 5 is a flowchart showing one example of an opening and closing determination process. The opening and closing determination process is executed, for example, when the driver monitoring function of the vehicle 50 is turned on.

As shown in FIG. 5, in S20, the face recognition ECU 20 of the driver monitoring system 101 causes the infrared image capturing unit 11 to capture an infrared image of the face of the driver. Thereafter, the face recognition ECU 20 proceeds to S21.

In S21, the face recognition ECU 20 causes the visible light image capturing unit 12 to capture a visible light image of the face of the driver. Thereafter, the face recognition ECU 20 proceeds to S22. S20 and S21 may be reversed in order, or may be performed at the same time.

In S22, the face recognition ECU 20 causes the color recognition unit 13 to recognize the color of the eyes of the driver and a color around the eyes of the driver. The recognition of the color of the eyes of the driver is not mandatory. Thereafter, the face recognition ECU 20 proceeds to S23.

In S23, the face recognition ECU 20 causes the opening and closing determination unit 21 to determine whether regions around the eyes of the driver are in a non-makeup state. When it is determined that the regions around the eyes of the driver are in a non-makeup state (S23: YES), the face recognition ECU 20 proceeds to S24. When it is not determined that the regions around the eyes of the driver are in a non-makeup state (S23: NO), the face recognition ECU 20 proceeds to S25.

In S24, the face recognition ECU 20 causes the opening and closing determination unit 21 to perform the determination of opening and closing of the eyes of the driver using the opening and closing determination logic for eyelids. The opening and closing determination unit 21 may use the opening and closing determination model for eyelids as the opening and closing determination logic for eyelids. The opening and closing determination unit 21 outputs a result of the determination of opening and closing of the eyes of the driver from the opening and closing determination model for eyelids, for example, by taking the color of the face (including the color of the eyes, the color around the eyes, or the like) of the driver recognized by the color recognition unit 13 and the infrared image captured by the infrared image capturing unit 11 as inputs. Thereafter, the opening and closing determination process is ended.

In S25, the face recognition ECU 20 causes the opening and closing determination unit 21 to determine whether the regions around the eyes of the driver are in a makeup state. When it is determined that the regions around the eyes of the driver are in a makeup state (S25: YES), the face recognition ECU 20 proceeds to S26. When it is not determined that the regions around the eyes of the driver are in a makeup state (S25: NO), the face recognition ECU 20 proceeds to S27.

In S26, the face recognition ECU 20 causes the opening and closing determination unit 21 to perform the determination of opening and closing of the eyes of the driver using the opening and closing determination logic for makeup. The opening and closing determination unit 21 may use the opening and closing determination model for makeup as the opening and closing determination logic for makeup. The opening and closing determination unit 21 outputs a result of the determination of opening and closing of the eyes of the driver from the opening and closing determination model for makeup, for example, by taking the color of the driver's face and the infrared image as inputs. Thereafter, the opening and closing determination process is ended.

In S27, the face recognition ECU 20 causes the opening and closing determination unit 21 to perform the determination of opening and closing of the eyes of the driver using the normal opening and closing determination logic. The opening and closing determination unit 21 may use the normal opening and closing determination model (opening and closing determination model 21a) as the normal opening and closing determination logic. The opening and closing determination unit 21 outputs a result of the determination of opening and closing of the eyes of the driver from the normal opening and closing determination model, for example, by taking the color of the driver's face and the infrared image as inputs. Thereafter, the opening and closing determination process is ended.

The face recognition ECU 20 may not perform the determination in S25, and may proceed to S26 when NO in S23. In addition, as in the first embodiment, the face recognition ECU 20 may select at least one of the opening and closing determination logic and the opening and closing determination model based on the color of the eyes of the driver.

According to the driver monitoring system 101 according to the second embodiment described above, by capturing a visible light image of the driver to recognize the color of the skin around the eyes of the driver, the opening and closing determination logic (opening and closing determination model) for the eyes of the driver using an infrared image can be changed based on the color of the skin around the eyes of the driver, so that even when makeup is performed to change the reflectance of light, the accuracy of the opening and closing determination can be improved compared to when the determination of opening and closing of the eyes of the driver is performed from the infrared image without taking into consideration the color of the skin around the eyes of the driver.

In addition, according to the driver monitoring system 101, by recognizing the color of the eyes of the driver in addition to the color of the skin around the eyes of the driver, the opening and closing determination logic can be changed based on a difference between the color of the eyes of the driver and the color of the skin around the eyes, so that the accuracy of the opening and closing determination can be further improved.

### Third Embodiment

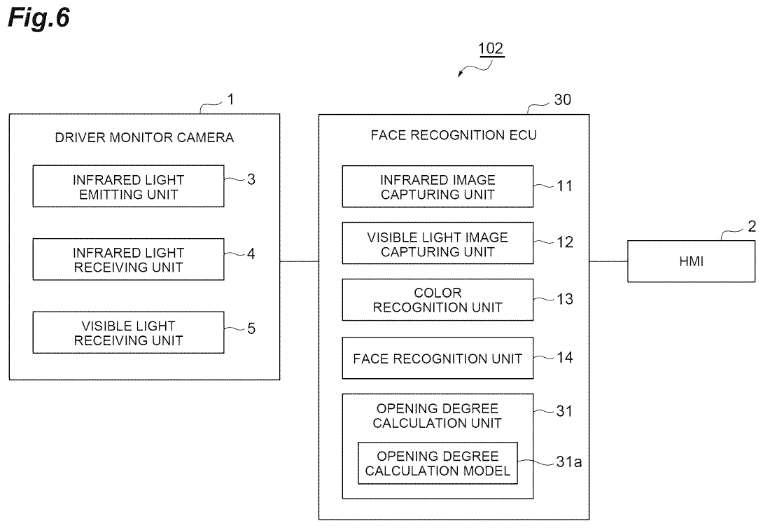

Next, a driver monitoring system 102 according to a third embodiment will be described with reference to the drawings. FIG. 6 is a block diagram showing the driver monitoring system 102 according to the third embodiment.

The driver monitoring system 102 according to the third embodiment shown in FIG. 6 performs the calculation of an opening degree of the mouth of the driver as a face recognition of the driver. As shown in FIG. 6, a face recognition ECU 30 of the driver monitoring system 102 differs from that of the first embodiment in that the face recognition ECU 30 includes an opening degree calculation unit 31.

The driver monitoring system 102 takes into consideration the recognition result of a color of the skin of the face of the driver and a color of lips of the driver in calculating the opening degree of the mouth of the driver. When there is a shield such as a plastic bottle in front of the mouth of the driver as seen from the driver monitor camera 1, when light hits the mouth of the driver unevenly, when the beard of the driver is thick and covers a part of the mouth, or the like, the calculation of the opening degree is falsely performed. For this reason, the driver monitoring system 102 can suppress false calculation of the opening degree by calculating the opening degree of the mouth of the driver in consideration of the recognition result of the color of the skin of the face of the driver and the color of the lips of the driver.

In the third embodiment, the visible light image capturing unit 12 does not continue to use a visible light image of the driver captured once, but uses a latest visible light image captured for each frame to recognize the color of the skin of the face of the driver and the color of the lips of the driver.

The opening degree calculation unit 31 performs the calculation of the opening degree of the mouth of the driver. The opening degree is the degree of opening of the mouth of the driver used for the determination of yawning of the driver or the like. The opening degree calculation unit 31 performs the calculation of the opening degree of the mouth of the driver based on the color of the driver's face (including the color of the lips of the driver) recognized by the color recognition unit 13 and the infrared image of the face of the driver captured by the infrared image capturing unit 11. The opening degree calculation unit 31 performs the calculation of the opening degree with a higher accuracy than when only the infrared image is used, by using a boundary between a color portion of the lips and a color portion of the skin of the face. When a visible light image cannot be calculated such as when light does not enter the vehicle from the outside at night, the opening degree calculation unit 31 may perform the calculation of the opening degree only from the infrared image.

First, the opening degree calculation unit 31 extracts feature points of the mouth of the driver from the infrared image. The opening degree calculation unit 31 recognizes, a mouth region, for example, through well-known image processing, and extracts the feature points of the mouth through at least one of edge detection and feature quantity extraction processing. The opening degree calculation unit 31 may extract the feature points of the mouth using a machine learning model.

The opening degree calculation unit 31 detects the boundary between the color portion of the lips (color recognition region of the lips) of the driver and the color portion of the skin of the face based on the recognition result of the color recognition unit 13. The color recognition unit 13 recognizes, for example, a portion around the mouth region of the driver, which has a certain difference or more from the color of the skin of the face region of the driver, as the lips. When the difference from the color of the skin of the face region is less than a certain value, the color recognition unit 13 may expand a target range including the mouth region, and may perform recognition of the lips.

The opening degree calculation unit 31 determines whether the color of the lips of the driver is within a non-makeup range estimated from the color of the driver's face. In other words, the opening degree calculation unit 31 determines whether it is difficult to calculate the opening degree of the mouth of the driver. The state where it is difficult to calculate the opening degree of the mouth of the driver is, for example, a state where a shield such as an eyeglass frame or a plastic bottle exists in front of the mouth of the driver, a state where light hits the mouth of the driver unevenly, a state where the beard around the mouth of the driver is thick, or the like. The opening degree calculation unit 31 performs the above-described determination, for example, using corresponding table data in which the ranges of the color of the skin of the face and the color of the lips estimated from the color of the skin of the face are associated with each other. Color can be determined as a numerical parameter such as RGB.

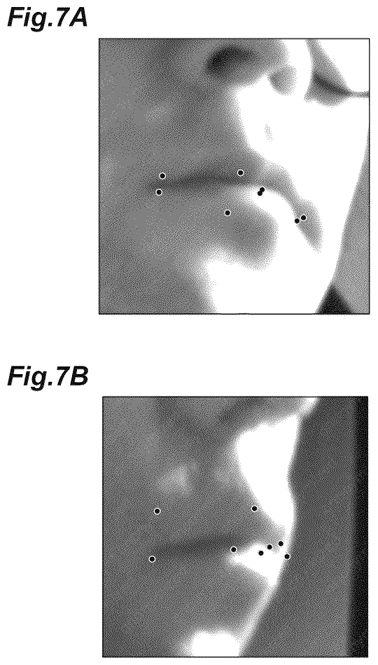

Here, FIG. 7A is a view showing an example in which false detection of feature points occurs due to light hitting the face of the driver unevenly. The feature points are shown as black dots. FIG. 7B is a view showing another example in which false detection of feature points occurs due to light hitting the face of the driver unevenly. As shown in FIGS. 7A and 7B, when light hits the mouth of the driver unevenly, false detection of feature points extracted from the infrared image occurs. Whether light hits unevenly enough to cause false detection of the feature points can be determined from a relationship between the color of the driver's face and the color of the lips of the driver recognized from the visible light image.

When the color of the lips of the driver is not within the non-makeup range estimated from the color of the driver's face, due to a high possibility of the occurrence of false detection of the feature points, the opening degree calculation unit 31 invalidates the feature points of the mouth, and does not perform the calculation of the opening degree. When it is determined that the color of the lips of the driver is within the non-makeup range estimated from the color of the driver's face, the opening degree calculation unit 31 determines whether a certain number or more of the feature points of the mouth exist within a certain distance from the color recognition region of the lips. The color recognition region of the lips is a region where the color of the lips is recognized in the visible light image. The values of the certain number and the certain distance are not particularly limited, but can be set to appropriate values to ensure the reliability of the calculation of the opening degree.

When a certain number or more of the feature points of the mouth do not exist within the certain distance from the color recognition region of the lips, due to a high possibility of the occurrence of false detection of the feature points, the opening degree calculation unit 31 does not perform the calculation of the opening degree. On the other hand, when the certain number or more of the feature points of the mouth exist within the certain distance from the color recognition region of the lips, the opening degree calculation unit 31 corrects the positions of the feature points to be included in the color recognition region of the lips, based on the boundary between the color recognition region of the lips of the driver and the color portion of the skin of the face.

The opening degree calculation unit 31 may perform the correction of the feature points using an opening degree calculation model 31a that is a machine learning model. The opening degree calculation model 31a can be a neural network similar to the face recognition model 14a described above.

Configurations of the neural networks of the opening degree calculation model 31a and the face recognition model 14a may be the same or different. The opening degree calculation model 31a outputs the corrected feature points of the mouth, for example, by taking the recognition result of the colors of the face and the lips by the color recognition unit 13 and the feature points of the mouth extracted from the infrared image as inputs. The opening degree calculation model 31a may take the infrared image itself and the recognition result of the colors of the face and the lips as inputs instead of the feature points of the mouth extracted from the infrared image. The calculation result of the opening degree is used, for example, for the determination of yawning of the driver.

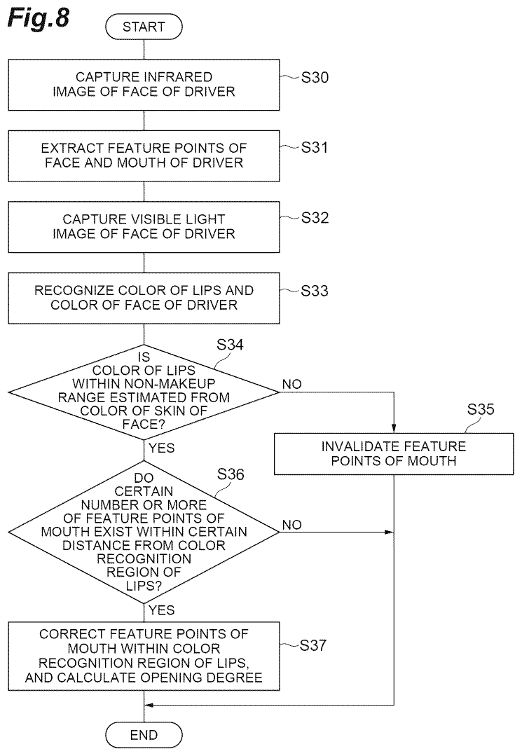

Next, a process of the driver monitoring system 102 will be described with reference to FIG. 8. FIG. 8 is a flowchart showing one example of an opening degree calculation process. The opening degree calculation process is executed, for example, when the driver monitoring function of the vehicle 50 is turned on.

As shown in FIG. 8, in S30, the face recognition ECU 30 of the driver monitoring system 102 causes the infrared image capturing unit 11 to capture an infrared image of the face of the driver. Thereafter, the face recognition ECU 30 proceeds to S31.

In S31, the face recognition ECU 30 causes the opening degree calculation unit 31 to extract feature points of the face and the mouth of the driver. The extraction of the feature points of the face may be performed by the face recognition unit 14. Thereafter, the face recognition ECU 30 proceeds to S32.

In S32, the face recognition ECU 30 causes the visible light image capturing unit 12 to capture a visible light image of the face of the driver. Thereafter, the face recognition ECU 30 proceeds to S33.

In S33, the face recognition ECU 30 causes the color recognition unit 13 to recognize the color of the face (including the color of the skin of the face) of the driver and the color of the lips of the driver. Thereafter, the face recognition ECU 30 proceeds to S34.

In S34, the face recognition ECU 30 causes the opening degree calculation unit 31 to determine whether the color of the lips of the driver is within the non-makeup range estimated from the color of the driver's face. When it is not determined that the color of the lips of the driver is within the non-makeup range estimated from the color of the driver's face (S34: NO), the face recognition ECU 30 proceeds to S35. When it is determined that the color of the lips of the driver is within the non-makeup range estimated from the color of the driver's face (S34: YES), the face recognition ECU 30 proceeds to S36.

In S35, the face recognition ECU 30 causes the opening degree calculation unit 31 to invalidate the feature points of the mouth of the driver. Thereafter, the face recognition ECU 30 ends the opening degree calculation process without calculating the opening degree.

In S36, the face recognition ECU 30 causes the opening degree calculation unit 31 to determine whether a certain number or more of the feature points of the mouth exist within a certain distance from the color recognition region of the lips. When it is not determined that the certain number or more of the feature points of the mouth exist within the certain distance from the color recognition region of the lips (S36: NO), the face recognition ECU 30 ends the opening degree calculation process without calculating the opening degree. When it is determined that the certain number or more of the feature points of the mouth exist within the certain distance from the color recognition region of the lips (S36: YES), the face recognition ECU 30 proceeds to S37.

In S37, the face recognition ECU 30 causes the opening degree calculation unit 31 to correct the feature points of the mouth to be included in the color recognition region of the lips, and to perform the calculation of the opening degree. The opening degree calculation unit 31 may perform the correction of the feature points or the calculation of the opening degree using the opening degree calculation model 31a.

According to the driver monitoring system 102 of the third embodiment described above, since the feature points of the mouth of the driver can be extracted from the infrared image, the feature points of the mouth can be corrected based on the boundary between the color portion of the lips of the driver and the color portion of the skin of the face from the visible light image, and the opening degree of the mouth of the driver can be calculated based on the corrected feature points of the mouth, the accuracy of the calculation of the opening degree can be improved compared to when the opening degree of the mouth of the driver is calculated from the infrared image without taking into consideration the color of the lips of the driver.

In addition, according to the driver monitoring system 102, when the color of the lips of the driver is not within the non-makeup range estimated from the color of the skin of the face, it is considered that the accuracy of detection of the mouth of the driver decreases due to the influence of lipstick or the like, so that the false calculation of the opening degree can be avoided by not performing the calculation of the opening degree.

The embodiments of the present disclosure have been described above; however, the present disclosure is not limited to the above-described embodiments. The present disclosure can be implemented in various modes in which various changes and improvements are made based on the knowledge of those skilled in the art, including the above-described embodiments.

The face recognition unit 14 does not necessarily include the face recognition model 14a. The face recognition unit 14 may execute face recognition of the driver without using a machine learning model. The same applies to the opening and closing determination unit 21 and the opening degree calculation unit 31.

What is claimed is:

1. A driver monitoring system configured to perform face recognition of a driver from a face image of the driver of a vehicle, the system comprising:
an infrared image capturing unit configured to capture an infrared image of a face of the driver using an infrared light emitting unit and an infrared light receiving unit;
a visible light image capturing unit configured to capture a visible light image of the face of the driver using a visible light receiving unit;
a color recognition unit configured to recognize a color of the driver's face based on the visible light image; and
a face recognition unit configured to perform the face recognition of the driver based on the color of the driver's face and the infrared image.

2. The driver monitoring system according to claim 1,
wherein the color of the driver's face includes a color of eyes of the driver, and
the face recognition unit is configured to change a face recognition logic for the driver in the infrared image according to the color of the eyes of the driver.

3. The driver monitoring system according to claim 2,
wherein when the color of the eyes of the driver is black, the face recognition of the driver is performed from the infrared image using a face recognition logic for black eyes, and when the color of the eyes of the driver is blue, the face recognition of the driver is performed from the infrared image using a face recognition logic for blue eyes.

4. The driver monitoring system according to claim 2,
wherein the visible light image capturing unit is configured to capture the visible light image of the driver when the driver is seated in a driver's seat of the vehicle or when an engine of the vehicle is started.

5. The driver monitoring system according to claim 2,
wherein the face recognition unit is configured to perform the face recognition of the driver from the face image of the driver using a face recognition model that is a machine learning model, and
one face recognition model is selected from a plurality of the face recognition models provided in advance, according to the color of the eyes of the driver, and the face recognition of the driver in the infrared image is performed using the selected face recognition model.

6. The driver monitoring system according to claim 1, further comprising:
an opening and closing determination unit configured to perform a determination of opening and closing of eyes of the driver based on a color of skin around the eyes of the driver included in the color of the driver's face and the infrared image,
wherein the opening and closing determination unit is configured to change an opening and closing determination logic for the eyes of the driver in the infrared image according to the color of the skin around the eyes of the driver.

7. The driver monitoring system according to claim 6,
wherein the color of the driver's face includes a color of the eyes of the driver, and
the opening and closing determination unit is configured to change the opening and closing determination logic for the eyes of the driver in the infrared image according to the color of the eyes of the driver and the color of the skin around the eyes of the driver.

8. The driver monitoring system according to claim 6,
wherein the opening and closing determination unit is configured to perform the determination of opening and closing of the eyes of the driver from the face image of the driver using an opening and closing determination model that is a machine learning model, and
one opening and closing determination model is selected from a plurality of the opening and closing determination models provided in advance, according to the color of the skin around the eyes of the driver, and the determination of opening and closing of the eyes of the driver in the infrared image is performed using the selected opening and closing determination model.

9. The driver monitoring system according to claim 1, further comprising:
an opening degree calculation unit configured to calculate an opening degree of a mouth of the driver based on the color of the driver's face including a color of lips of the driver and the infrared image,
wherein the opening degree calculation unit is configured to extract feature points of the mouth of the driver from the infrared image, correct the feature points of the mouth based on a boundary between a color portion of the lips of the driver and a color portion of skin of the face from the visible light image, and calculate the opening degree of the mouth of the driver based on the corrected feature points of the mouth.

10. The driver monitoring system according to claim 9,
wherein the opening degree calculation unit is configured to determine whether the color of the lips of the driver is within a non-makeup range estimated from a color of the skin of the face, perform the calculation of the opening degree when the color of the lips of the driver is within the non-makeup range, and not perform the calculation of the opening degree when the color of the lips of the driver is not within the non-makeup range.
